(19) United States
(12) Patent Application Publication
(10) Pub. No.: US 2026/0243991 A1
(43) Pub. Date: Aug. 20, 2026

(54) PRECISION LENGTH FIBER OPTIC CABLE

(71) Applicant: CommScope Technologies LLC, Claremont, NC (US)

(72) Inventors: David John ANDERSON, Bloomington, MN (US); Paul SCHNEIDER, Gemonde (NL)

(73) Assignee: CommScope Technologies LLC, Claremont, NC (US)

(21) Appl. No.: 19/159,807

(22) PCT Filed: Feb. 29, 2024
(86) PCT No.: PCT/US2024/017880

§ 371 Date: Aug. 26, 2025

Related U.S. Application Data
(60) Provisional application No. 63/449,540, filed on Mar. 2, 2023.

(51) Int. Cl. G02B 6/44; G02B 6/46

(52) U.S. Cl. CPC G02B 6/4484; G02B 6/44528; G02B 6/4471; G02B 6/46

(57) ABSTRACT

A fiber optic cable with a defined length of at least 300 meters, including a fiber extension cable with a first length between a first connectorized end and a second end, and a fiber pigtail cable with a second length between a third end and a fourth connectorized end. The initial combined length of both cables exceeds the defined cable length. The fiber extension cable and/or the fiber pigtail cable is trimmed, and the second end of the fiber extension cable is spliced to the third end of the fiber pigtail cable to achieve the defined cable length within a defined tolerance.

### CROSS-REFERENCE TO RELATED APPLICATION

This application is being filed on Feb. 29, 2024, as a PCT International Application and claims the benefit of U.S. Provisional Application No. 63/449,540 filed on Mar. 2, 2023, the disclosure of which is hereby incorporated herein by reference in its entirety.

### TECHNICAL FIELD

The present disclosure relates generally to fiber optic cables, and more particularly to multi-fiber optic cables where every optical fiber within the cable is precisely manufactured to a specified length within a defined tolerance.

### BACKGROUND

Fiber optic cables are made up of thin strands of glass or plastic that can transmit data and signals using light pulses instead of electrical signals. These cables have revolutionized the telecommunications industry by allowing for faster and more efficient communication over long distances.

Today, fiber optic technology is used in various applications, such as financial systems, medical equipment, military systems, and industrial automation. One of the advantages of fiber optic systems is their ability to transmit data over longer distances with less signal degradation than traditional copper cables. Additionally, fiber optic cables are less susceptible to electromagnetic interference, making them more reliable and secure.

To connect fiber optic systems in the field, one or more fiber optic cable assemblies are typically used. These systems typically include a length of fiber optic cable with fiber optic connectors mounted at opposing ends of the cable. In some cases, an adapter for mechanically and optically coupling one or more connectors together may also be provided. With the connectors aligned within the adapter, a fiber optic signal can pass from one cable to the next.

### SUMMARY

Some aspects of the disclosure are directed to a long cable manufactured to a specific length with an extremely tight tolerance to ensure that the latency associated with the cable meets customer requirements. In many cases, such this type of cable would be a ruggedized, multi-fiber cable that spans several hundred meters, wherein each fiber of the multi-fiber cable is individually manufactured to have a nearly identical latency to every other fiber in the multi-fiber cable.

One embodiment of the present disclosure provides a multi-fiber equidistant connecting cable assemblies with extremely tight length tolerance requirements. These assemblies can include multi-fiber bundles that exceed 50 meters in length, where each fiber within the bundle is spliced to a specified length within a defined tolerance, to ensure that all fibers are nearly identical in length. One example of a multi-fiber bundle is a 1728 fiber cable, which contains 1728 fibers arranged in ribbons or loose strands to provide durability and reliability in harsh environmental conditions. Other non-limiting examples of multi-fiber bundles include 864, 576, 288, or 96 fibers, in either a ribbon format or stranded fiber format. The connecting cable assembly products can be pre-terminated and can include an LC to LC connection, an LC to MPO connection, or an MPO to MPO connection making the assemblies compatible with existing optical systems.

The present disclosure addresses the problem of accurately determining a length of a fiber optic cable by introducing a production technique, which uses a time-of-flight process to measure the travel time of an optical signal from one end of a fiber extension cable to the other end of the fiber extension cable, enabling the precise calculation of the cable's length. In one implementation, after determining the precise length of the fiber extension cable, a shorter cable, typically less than 1-3 meters in length, is spliced to one end of the extension cable to form a completed cable of a specified length within a defined tolerance. Through this production technique, long fiber optic cables (e.g., cables in excessive 50 meters in length) can be produced to a precise length within an acceptable tolerance.

Aspects of the present disclosure relate to fiber optic cable having a defined cable length of at least 50 meters, the fiber optic cable including a fiber extension cable having a first length extending between a first connectorized end and a second end, wherein a length of the fiber extension cable between the first connectorized end and the second end is determined by a time-of-flight process in which an observed travel time for an optical signal traversing from the first connectorized end to the second end is multiplied by a velocity of the optical signal; a fiber pigtail cable having a second length extending between a third end and a fourth connectorized end, wherein an initial combined length of the fiber extension cable and the fiber pigtail cable exceeds the defined cable length, wherein at least one of the fiber extension cable in proximity to the second end or the fiber pigtail cable in proximity to the third end is trimmed, and wherein the second end of the fiber extension cable is spliced to the third end of the fiber pigtail cable, and wherein a resulting combined length of the fiber extension cable and the fiber pigtail cable equals the defined cable length within a tolerance of 0.1% of the defined cable length.

In certain implementations, the first connectorized end of the fiber extension cable includes at least one of an MTP/MPO connector, a duplex LC connector, or an LC connector. In certain implementations, the fourth connectorized end includes at least one of an MTP/MPO connector, a duplex LC connector, or an LC connector.

In certain implementations, the fiber optic cable comprises a trunk portion and one or more breakout sections. In certain implementations, the trunk portion comprises at least one of 1728, 864, 576, 288, or 96 fibers. In certain implementations, the fiber optic cable comprises cable in at least one of a ribbon format, stranded format, or loose fiber format. In certain implementations, at least one of the first connectorized end or fourth connectorized end terminates in a fiber optic panel. In certain implementations, the fiber optic panel defines a plurality of ports configured to receive a corresponding plurality of adapters. In certain implementations, the fiber optic panel defines one or more cable management features configured to aid in the storage of excess fiber optic cable.

Another aspect of the present disclosure relates to a method for producing a fiber optic cable, including defining a cable length of at least 50 meters; providing a fiber extension cable having a first length extending between a first connectorized end and a second end; determining a length of the fiber extension cable between the first connectorized end and the second end, wherein the length of the fiber extension cable is determined by a time-of-flight process in which an observed travel time for an optical signal traversing from the first connectorized end to the second end is multiplied by a velocity of the optical signal; providing a fiber pigtail cable having a second length extending between a third end and a fourth connectorized end, wherein an initial combined length of the fiber extension cable and the fiber pigtail cable exceeds the defined cable length; cutting at least one of the fiber extension cable in proximity to the second end or the fiber pigtail cable in proximity to the third end; and splicing the second end of the fiber extension cable to the third end of the fiber pigtail cable, wherein a resulting combined length of the fiber extension cable and the fiber pigtail cable equals the defined cable length within a tolerance of 0.1% of the defined cable length.

Another aspect of the present disclosure relates to an apparatus for measuring a length of an optic cable, including a light source configured to generate an optical signal; an optical conduit traversing from the light source to a beginning reference node; a first photodetector and a second photodetector positioned along the optical conduit, each of the first photodetector and second photodetector configured to detect the optical signal generated by the light source; a reference loop of optical conduit of a known length positioned between the first photodetector and the second photodetector, wherein a difference in time between detection of the optical signal by the first photodetector and detection of the optical signal by the second photodetector is divided by the known length of the reference loop to determine a velocity of the optical signal; and a third photodetector, wherein the optic cable is connectable between the beginning reference node and an end reference node positioned in proximity to the third photodetector, wherein the third photodetector is configured to detect the optical signal generated by the light source traversing through the optic cable, and wherein a difference in time between detection of the optical signal by the second photodetector and detection of the optical signal by the third photodetector is multiplied by the velocity of the optical signal to determine the length of the optical cable.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a schematic view of a fiber optic cable, in accordance with an embodiment of the disclosure.

FIG. 2 is a perspective view of a first type of connector, in accordance with an embodiment of the disclosure.

FIG. 3 is a perspective view of a second type of connector, in accordance with an embodiment of the disclosure.

FIG. 4 is a perspective view of a third type of connector, in accordance with an embodiment of the disclosure.

FIG. 5 is a partial cross-sectional, perspective view depicting a fiber optic cable, in accordance with an embodiment of the disclosure.

FIG. 6 is a schematic view depicting a fiber optic cable including a first and second panel, in accordance with an embodiment of the disclosure.

FIG. 7 is a schematic view depicting components of a fiber optic cable, in accordance with an embodiment of the disclosure.

FIG. 8 is a first schematic view depicting assembly of a fiber optic cable, in accordance with an embodiment of the disclosure.

FIG. 9 is a second schematic view depicting assembly of the fiber optic cable of FIG. 8, in accordance with an embodiment of the disclosure.

FIG. 10 is a schematic view depicting a fiber optic cable extending between a first panel and a second panel, in accordance with an embodiment of the disclosure.

FIG. 11 is an apparatus for measuring a length of a fiber optic cable, in accordance with an embodiment of the disclosure.

### DETAILED DESCRIPTION

Reference will now be made in detail to exemplary aspects of the present disclosure that are illustrated in the accompanying drawings. Wherever possible, the same reference numbers will be used throughout the drawings to refer to the same or like parts.

The length of a fiber optic cable can significantly impact the time it takes for a signal to be transmitted. As light travels through the cable, it experiences a slight delay caused by the physical properties of the fiber, including the refractive index and the length of the fiber. This delay, also known as latency, is directly proportional to the length of the fiber optic cable. In other words, the longer the cable, the greater the latency. This can be especially important for applications that require real-time data transmission, such as video conferencing, online gaming, and financial systems, among others.

For example, high-speed financial trading relies heavily on algorithms, which are computer programs that are designed to make quick and accurate trading decisions. These algorithms use complex mathematical models to analyze data and identify potential trading opportunities in real-time. In high-speed financial trading, even a small delay in the transmission of data can result in significant losses. Therefore, the time it takes for a signal to be transmitted between trading processors is critical, as the length of the fiber optic cable can have a direct impact on the transaction times as light travels through the cable at a finite speed.

Variations in length between processors can lead to situations where some customers with shorter cables have an advantage over others, as they can receive information and take action on that information faster than those with longer cables. This advantage can be significant, with some estimates suggesting that fractions of a second of latency can have a large impact in profit or loss for high-frequency traders. The use of such fiber optic cables in high-speed financial transactions represents one example where precision in fiber optic cable length is critical, and should not be considered limiting to the scope of this disclosure.

To minimize latency, it is important to ensure that the fiber optic cables used are of the appropriate length and that any excess cable is properly managed to prevent signal distortion or delay. The problem of accurately determining the length of an optical fiber cable is compounded by the fact that the individual fibers within a bundle of fibers may not be of uniform length. That is, simply measuring the exterior length of the cable can be misleading and lead to inaccurate measurements.

In particular, when ribbonized or stranded optical fibers are bundled, they may not be evenly spaced, and some fibers may weave through the bundle and wrap around other fibers in the bundle. This can result in each fiber being a slightly different length, with some fibers primarily positioned on the outside of the bundle being longer than those positioned on the inside. This problem is exacerbated in longer cables, for instance, those exceeding 50 meters. As a result, the production of longer multi-fiber cables where each of the optical fibers within the bundle is fabricated to a precise length within an acceptable tolerance has been elusive.

The present disclosure presents a solution to this problem through a new production technique in which a precise length of a fiber extension cable is determined by a time-of-flight process in which an observed travel time for an optical signal traversing from one end of the cable to the other end of the cable is used to determine the precise length of the fiber extension cable. Thereafter, a shorter cable, also of a precise length (e.g., less than about 1-3 meters), can be spliced to one end of the extension cable to form a completed cable of an exact length within an acceptable tolerance (e.g., between about ±0.1% and about ±0.01%, etc.) of the targeted total length of the fiber optic cable.

Reference will now be made in detail to exemplary aspects of the present disclosure that are illustrated in the accompanying drawings. Wherever possible, the same reference numbers will be used throughout the drawings to refer to the same or like parts.

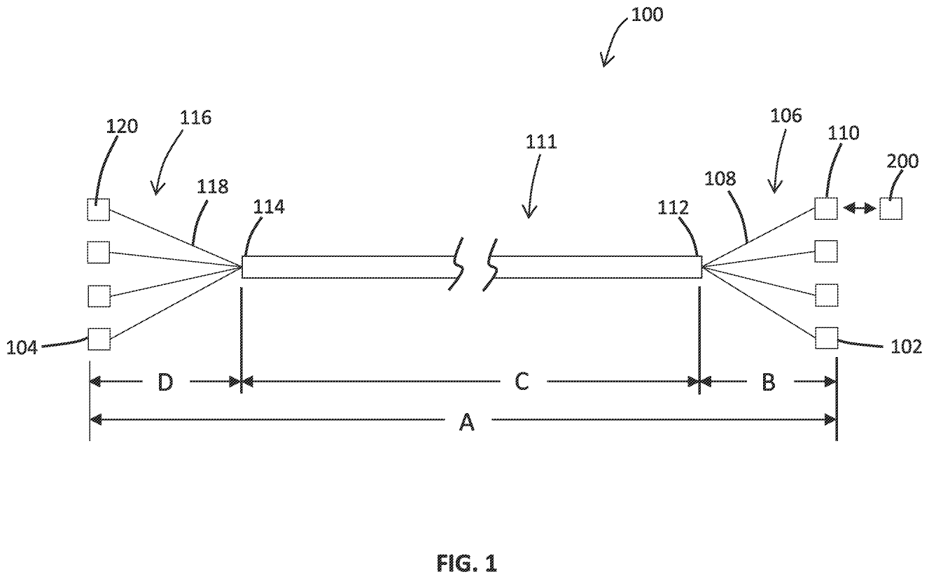

With reference to FIG. 1, a fiber optic cable 100 is depicted in accordance with an embodiment of the disclosure. As depicted, the fiber optic cable 100 can extend between a first end 102 and a second end 104 to define a total length (A). In some embodiments, the first end 102 can define a first breakout section 106 defining one or more breakout cables 108, which can optionally terminate in one or more connectors 110. In some embodiments, the first breakout section 106 (e.g., each of the breakout cables 108) can extend from the first end 102 to a trunk portion first end 112 to define a first breakout section length (B).

A trunk portion 111 representing a bundle of the one or more breakout cables 108 can extend from the trunk portion first end 112 to a trunk portion second end 114 to define a trunk length (C). In some embodiments, the second end 104 can define a second breakout section 116 defining one or more breakout cables 118, which can optionally terminate in one or more connectors 120. In some embodiments, the second breakout section 116 (e.g., including each of the breakout cables 118) can extend from the trunk portion second end 114 to the second end 104 of the fiber optic cable 100 to define a second breakout section length (D). Collectively, the first breakout section length (B), trunk length (C), and second breakout section length (D) add up to the total length (A). In some embodiments, the total length (A) of the fiber optic cable can be a minimum of 50 meters or any length that cannot be achieved through conventional length measurement techniques to construct a fiber optic cable with the appropriate length tolerance between connectors 110 and 120. In some embodiments, the total length (A) can be any length between about 50 meters and about 4000 meters, with various incremental lengths of the fiber optic cable 100 (e.g., 100 m, 150 m, 500 m, 750m, 1000m, 1500 m, 2000 m, 2500 m, 3000 m, etc.) contemplated.

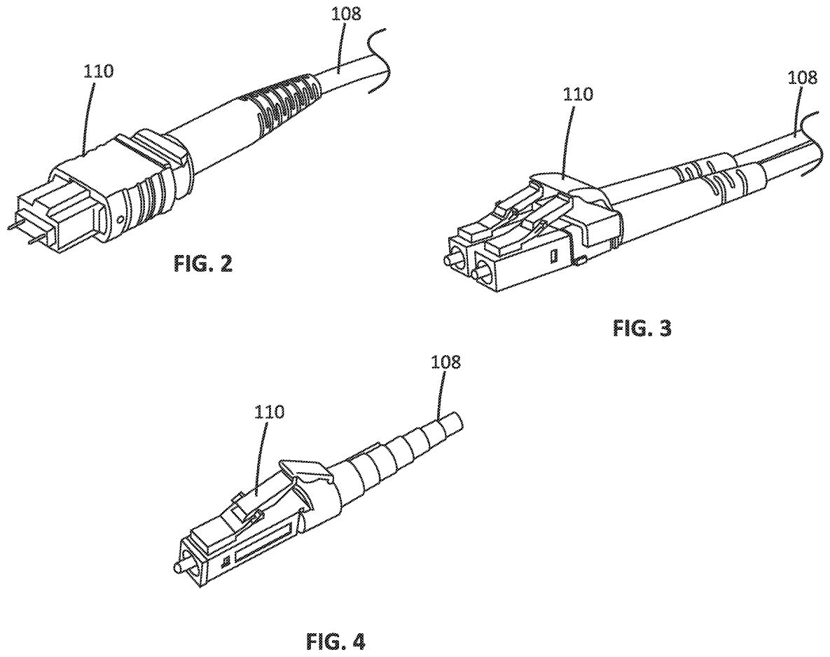

Although the fiber optic cable 100 is depicted as having only four connectors 110, 120 respectively on each the first end 102 and the second end 104 of the fiber optic cable 100, the number of connectors largely depends on the number of fibers contained in the trunk portion 111. For example, in some embodiments, the trunk portion 111 may be a 1728 fiber cable, containing 1728 fibers arranged in ruggedized ribbons, which can be broken out into 144 separate breakout cables each terminating in a 12-fiber MTP/MPO connector (as depicted in FIG. 2). In other embodiments, the 1728 fiber can be broken out into 864 duplex LC connectors (as depicted in FIG. 3). In other embodiments, the 1728 fiber can be broken out into 1728 individual LC connectors (as depicted in FIG. 4), or other types of connectors individual fiber connectors (e.g., SC connectors, etc.). In other embodiments, the connectors 110, 120 can be ferrule-less connectors.

In embodiments, various combinations of different connectors can be used together on the fiber optic cable 100. For example, depending upon the needs of the user, in some embodiments, the first end 102 may be outfitted with MPO connectors, while the second end 104 may be outfitted with LC connectors, etc. Additionally, although 1728 fiber cable is referenced, the fiber optic cable 100 and the methods described herein may be employed with any type of optical fiber, including but not limited to, multi-fiber bundles including 864, 576, 288, or 96 fibers, in a ribbon format, or stranded fiber format.

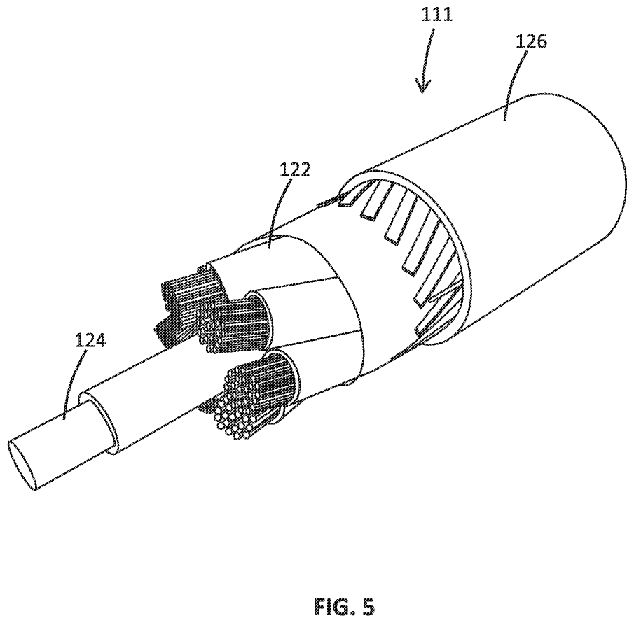

As depicted in FIG. 5, in some embodiments, at least the trunk portion 111 can be comprised of a series of bundles of fibers 122 surrounding a strength member 124, which collectively can be wrapped in a jacket 126. Additionally, in some embodiments, the trunk portion 111, and any of the connectors can be armored or ruggedized to withstand harsh environmental conditions and to provide protection against physical damage.

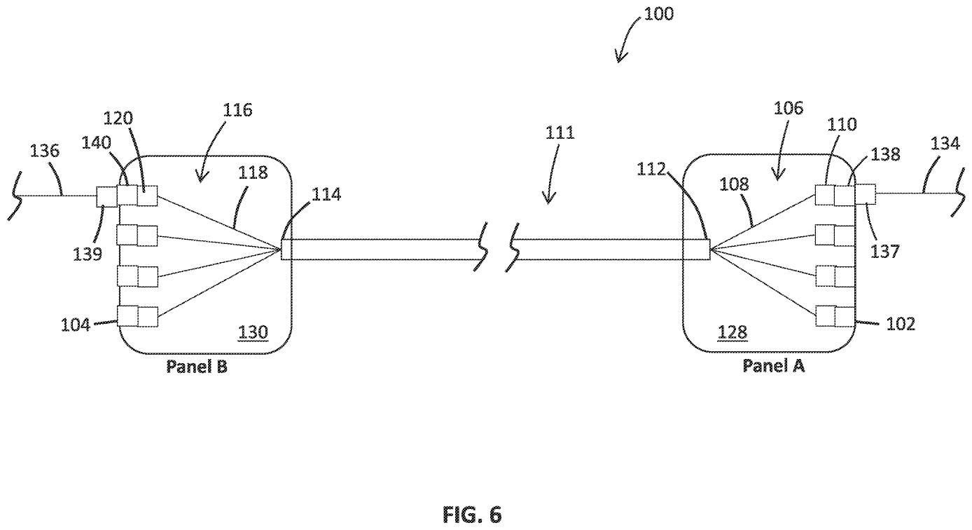

With additional reference to FIG. 6, another embodiment of a fiber optic cable 100 is depicted in accordance with an embodiment of the disclosure. In this embodiment, the fiber optic cable 100 can terminate in a respective panels, for example, one or more first panels 128 (e.g., Panel A, etc.) and one or more second panels 130 (e.g., Panel B, etc.). In embodiments, the panels 128, 130, occasionally referred to herein as patch panels or fiber distribution panels, can be configured to terminate and manage individual fiber optic cables for easy management of fiber optic connections.

In embodiments, the first panel 128 and/or second panel 130 can include a metal or plastic enclosure containing a series of adapter ports 132 or sleeves for connecting fiber optic connectors. In some embodiments, the ports 132 are arranged in rows, with each row corresponding to a specified cable or group of cables. In some embodiments, the panels 128, 130 may also include cable management features, such as cable guides or trays to help organize and protect the cables.

As depicted, to facilitate interconnection of the panels 128, 130 with other portions of the data center or telecommunications network, in some embodiments, one or more patch cords or jumper cables 134, 136 can be configured to couple to the connectors 110, 120, for example via connectors 137, 139 adapters 138, 140. To provide additional protection against physical damage, in some embodiments, the respective trunk portion first end 112 and/or trunk portion second and 114 can extend into the respective panels 128, 130.

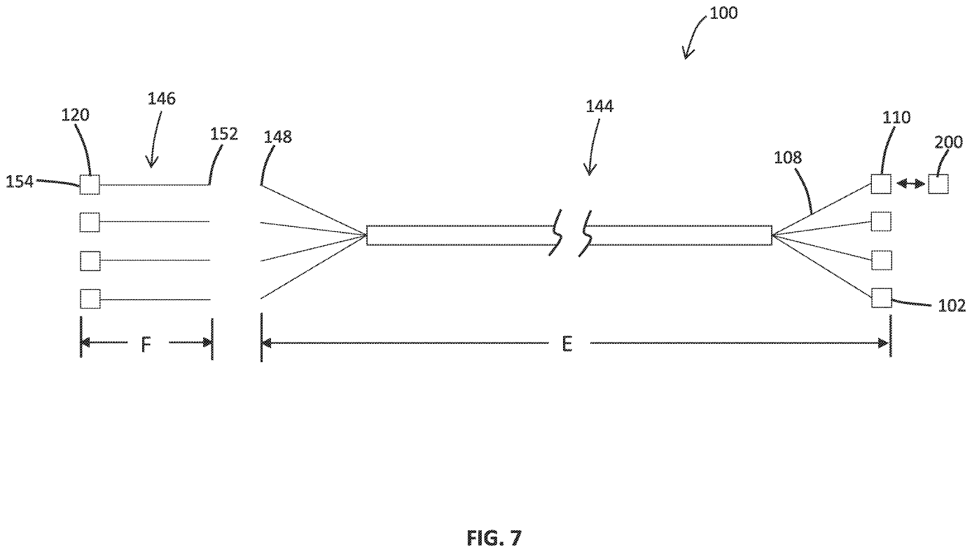

With additional reference to FIG. 7, in some embodiments, the fiber optic cable 100 can be assembled by coupling a fiber extension cable 144 having a length (E), with a fiber pigtail cable 146 having a length (F), such that assembly of the fiber extension cable 144 with the fiber pigtail cable 146 creates a fiber optic cable 100 having a total length (A). In some embodiments, the fiber extension cable 144 can extend between the first end 102, which can be outfitted with one or more connectors 110, and a second end 148, which in some embodiments can be free from connectors (e.g., bare fiber, etc.). In some embodiments, a length of the fiber extension cable 144 and be determined through a time-of-flight process, in which an observed travel time for an optical signal traversing from the first end 102 to the second end 148 is multiplied by a velocity of the optical signal to determine a precise length of the fiber extension cable 144 between the first end 102 and the second end 148.

In embodiments, the fiber pigtail cable 146 can have a second known length extending between a third end 152, and a fourth end 154. With knowledge of the precise length of the fiber extension cable 144, either of the fiber extension cable 144 or the fiber pigtail cable 146 can be cut, such that the total length of the fiber extension cable 144 having a length (E) and the fiber pigtail cable 146 having a length (F) equals the total length (A). Thereafter, the second end 148 of the fiber extension cable 144 can be spliced to the third end 152 of the fiber pigtail cable 146, wherein the resulting combined length of the fiber extension cable 144 and the fiber pigtail cable 146 equals the total length (A) within an acceptable tolerance.

In some embodiments, the acceptable tolerance can be represented as a percentage of the total length (A). For example, a 50 meter cable with the maximum tolerance of 3 inches (±1.5 inches or ±0.0381 meters) is equivalent to about ±0.0762% (e.g., 0.0381 meters/50 meters×100%). In another example, a 4000 meter (e.g., 4 km) cable with the maximum tolerance of ±0.0381 meters is equivalent to about ±0.0009525% (e.g., 0.0381 meters/4000 meters×100%). Other tolerance limits are also contemplated. For example, in some embodiments, the acceptable tolerance can be represented in terms of a maximum length that can be added or subtracted to the total length (A) while still meeting and customer latency demands. In other embodiments, the acceptable tolerance can range from less than about 0.1% to less than about 0.001%. Other tolerance limits that satisfy user latency requirements are also contemplated.

For example, in one embodiment, the total length can measure about 50 m within a tolerance of about 0.1% of the total length. In one embodiment, the total length can measure about 100 m within a tolerance of about 0.038% of the total length. In one embodiment, the total length can measure about 150 m within a tolerance of about 0.025% of the total length. In one embodiment, the total length can measure about 400 m within a tolerance of about 0.01% of the total length. In one embodiment, the total length can measure about 500 m within a tolerance of about 0.008% of the total length. In one embodiment, the total length can measure about 1000 m within a tolerance of about 0.004% of the total length. In one embodiment, the total length can measure about 1500 m within a tolerance of about 0.003% of the total length. In one embodiment, the total length can measure about 2000 m within a tolerance of about 0.0019% of the total length. In one embodiment, the total length can measure about 2500 m within a tolerance of about 0.0015% of the total length. In one embodiment, the total length can measure about 3000 m within a tolerance of about 0.0013% of the total length. In one embodiment, the total length can measure about 4000 m within a tolerance of about 0.001% of the total length.

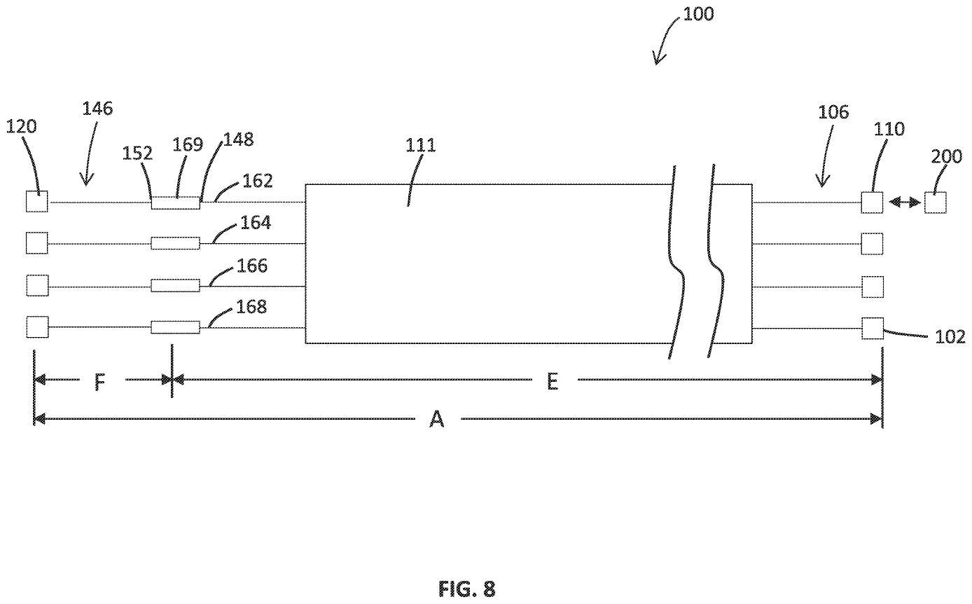

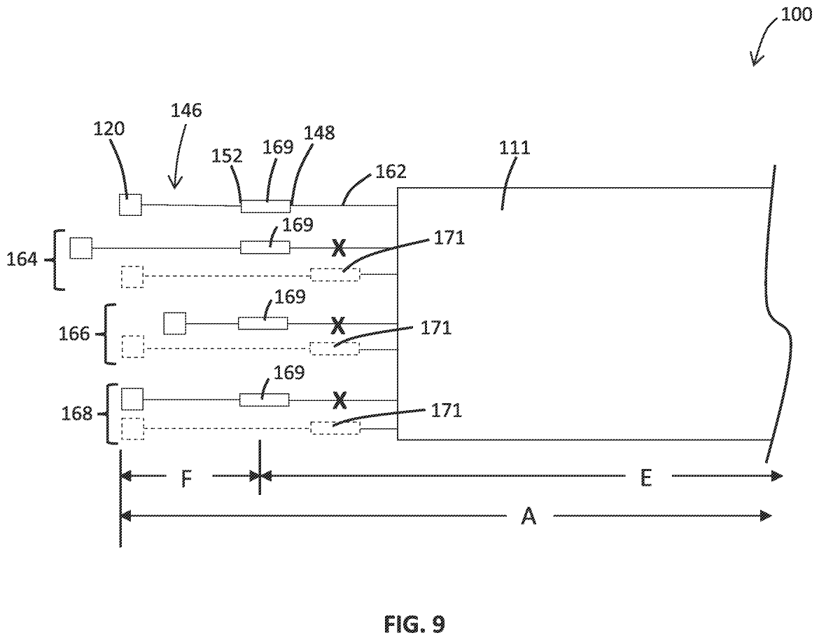

With additional reference to FIGS. 8-9, a close up view of the fiber optic cable 100 of FIG. 7 is depicted in accordance with an embodiment of the disclosure. During fabrication each of the fibers or bundle of fibers within the fiber optic cable 100 can be cut and spliced to a specific length within a given tolerance. In the example shown, the disposition of four distinct fibers or bundles of fibers, including first fiber 162, second fiber 164, third fiber 166, and fourth fiber 168, is shown. The disclosed disposition and fabrication techniques in this example are simply meant to illustrate the various types of fabrication techniques that can be used within the context of this disclosure, and should not be viewed as limiting in any way.

In the example shown, the first fiber 162 meets the length/tolerance requirements, such that no further cutting or splicing is necessary. Accordingly, the fiber extension cable 144 can be spliced to the fiber pigtail cable 146 with splice 169 to create the first fiber 162 of total length (A) within the given tolerance limit.

In embodiments, the splice 169, which can be any splice on the fiber optic cable 100 (e.g., between the second end 148 of the fiber extension cable 144 to the third end 152 of the fiber pigtail cable 146) can be one of a number of different types of optical splices. For example, in some embodiments, the splice 169 can be a fusion type splice which involves melting the ends of the two fibers together to form a permanent bond. In some embodiments, the fibers are aligned using a fusion splicer machine, which applies heat to the ends of the fibers until they melt and fuse together. Other types of splices, including a mechanical splice, ribbon splice, bare fiber splice, pigtail splice, and mid-span splice are also contemplated.

With continued reference to FIGS. 8-9, in the depicted example, the second fiber 164 was tested to initially have a length (E), which is too short, such that adding the length (E) of the fiber pigtail cable 146, was insufficient to create a second fiber 164 having a total length (A) that meets end-user requirements, in which case the original second fiber 164 can be cut and replaced with a new second fiber 164 including replacement splice 171 to establish the required total length (A) within the acceptable tolerance.

In the depicted example, the third fiber 166 was tested to be too long, in which case the original third fiber 166 can be cut and replaced with a new third fiber 166 including replacement splice 171 to establish a required total length (A) within the acceptable tolerance. In the depicted example, the fourth fiber 168 was tested and it was determined that a portion of the fourth fiber 168 downstream of the splice 169 was defective, in which case the original fourth fiber 168 can be cut and replaced with a new fourth fiber 168 including replacement splice 171 to establish a required total length (A) within the acceptable tolerance.

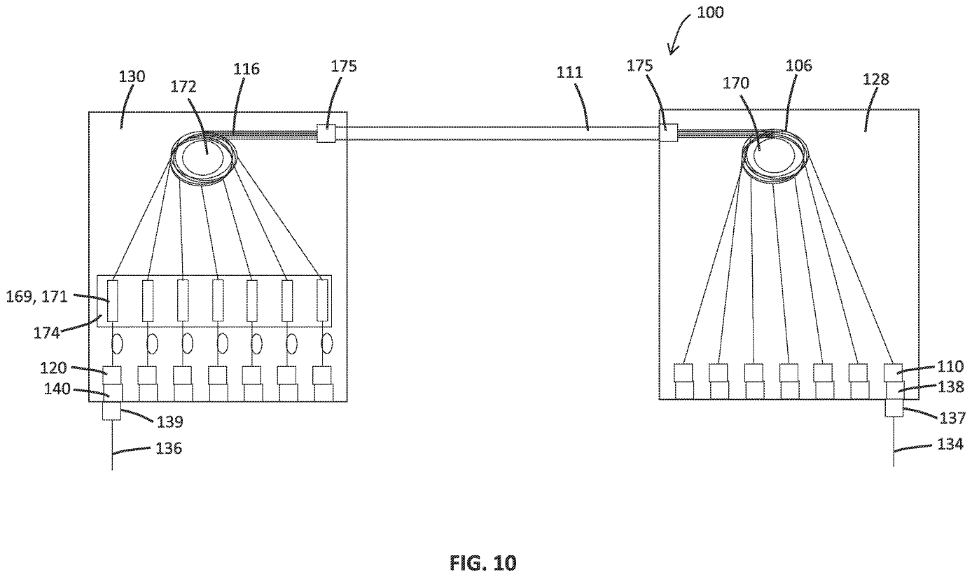

With additional reference to FIG. 10, another embodiment of a fiber optic cable 100 is depicted in accordance with an embodiment of the disclosure. Like previous examples, the fiber optic cable 100 can traverse between a first panel 128 and a second panel 130. Fiber optic panels, such as first panel 128 and second panel 130 are commonly used in data centers, telecommunications networks, and other applications where large numbers of fiber optic connections need to be managed in a structured and organized manner.

As further depicted, the fiber optic cable 100 can include a first breakout section 106 including connectors 110 housed within the first panel 128. In particular, the connectors 110 can be operably coupled to a series of adapters 138 which can be affixed in one or more ports defined by the first panel 128. Further, in some embodiments, the first panel 128 can include a cable management feature 170 configured to organize and secure a portion of the first breakout section 106. A trunk portion 111 can traverse between the first breakout section 106 and a second breakout section 116. In some embodiments, the panel 128 can include a clamp 175 configured to at least partially restrain a portion of the cables (e.g., trunk portion 111, etc.).

The second panel 130 can be similar to the first panel 128, in that the second panel 130 can include one or more cable management features 172 configured to organize and secure a portion of the second breakout section 116. Further, in some embodiments, the second panel 130 can include one or more splice holders 174 to allow for improved organization and retention of the splices contained within the second panel 130. The connectors 120 of the second breakout section 116 can be operably coupled to a series of adapters 140 which can be affixed in one or more ports defined by the second panel 130. Thereafter a series of patch cords or jumper cables 134, 136 can be used to optically connect the adapters 138, 140 to various other components of a larger fiber optic network or system.

In some embodiments, specific length measurements of the fiber optic cable 100 and components of the fiber optic cable (e.g., fiber extension cable, etc.) can be performed through a method in which an observed travel time for an optical signal traversing from one end of the cable to the other end of the cable is used to determine the precise length of the fiber extension cable, generically referred to as a time-of-flight process or method. Although various types of optical test equipment can provide general guidance as to a length a fiber optic cable, not all methods are precise enough to meet end user demands.

For example, an Optical Time Domain Reflectometer (OTDR) is a device used to test and troubleshoot fiber optic cables, including buried optical cables. An OTDR works by sending a pulse of light into the fiber and measuring the time and strength of the light reflected back from various points along the cable.

When a fiber optic cable is buried, it is susceptible to damage from a variety of factors, such as ground movement, excavation, or animal interference. If a break or other type of damage occurs in the cable, it can disrupt or even completely cut off the signal being transmitted. To locate the location of the break or damage, an OTDR is used to perform a series of tests along the length of the cable. The device sends a pulse of light into the cable, which travels down the fiber and is partially reflected back when it encounters a change in the fiber's refractive index. By analyzing the timing and strength of these reflections, an OTDR can determine the location and severity of any breaks or other damage in the cable.

The OTDR works by injecting a short pulse of light into one end of the fiber and then detecting the reflected light at the same end. The instrument then measures the time taken for the pulse to travel through the fiber and return back to the source, as well as the amount of reflected light. As the pulse travels through the fiber, it encounters changes in the refractive index caused by variations in the fiber's material, geometry, or any faults in the fiber. These variations in the fiber cause some of the light to reflect back towards the source, which is detected by the OTDR.

The OTDR then measures the time delay and the intensity of the reflected light to determine the distance to the fault and the amount of light loss that occurred. The OTDR also analyzes the shape of the backscattered signal to determine the location and type of fault or event in the fiber. For example, a break in the fiber will create a sharp drop in the backscattered signal, while a connector or splice will create a less abrupt change in the signal.

It is important to note that while an OTDR can provide length measurements of an optical fiber, in many cases, these measurements are only accurate enough to identify the general location of a break or other type of damage. The length measurements provided by an OTDR may not be accurate enough to determine a precise length within a given tolerance that is acceptable to an end user with specific latency requirements. This is because factors such as temperature, fiber attenuation, and other variables can affect the accuracy of length measurements obtained by an OTDR. Accordingly, as an alternative to OTDR, other time-of-flight methods may be used for more precise length measurements.

For example, in some embodiments, the time-of-flight method may be performed with the device that represents a combination of an OTDR and an optical power meter. An optical power meter is an instrument used to measure the optical power of a light signal in a fiber optic system. It measures the power of the light signal in units of dBm (decibels per milliwatt). Optical power meters work by detecting the light signal and converting it into an electrical signal, which is then amplified and processed to provide an accurate power reading.

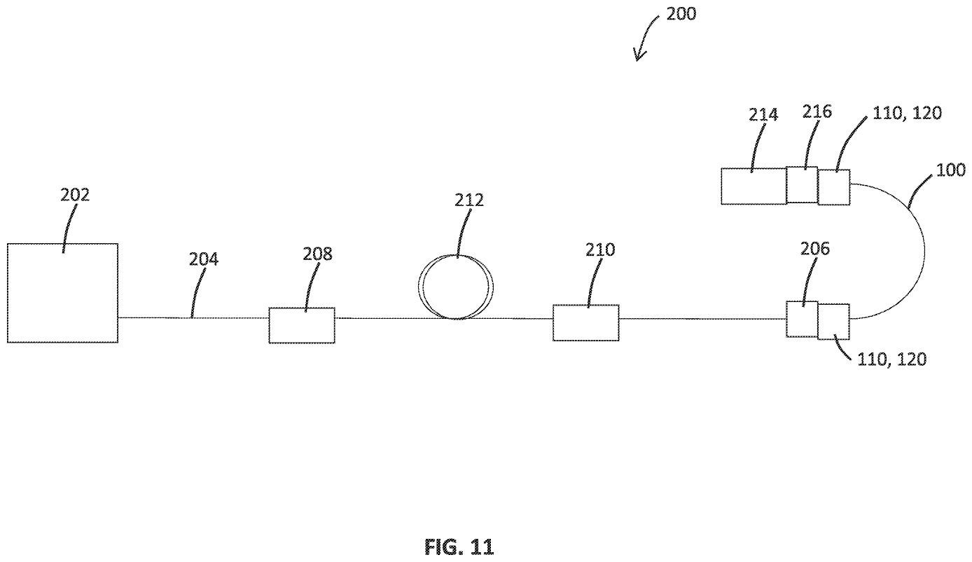

With additional reference to FIG. 11, a time-of-flight test measurement device 200 is depicted in accordance with an embodiment of the disclosure. In embodiments, the device 200 can include a light source 202 configured to generate an optical signal. For example, in one embodiment, the light source 202 can be a laser diode, such as a Fabry-Perot (FP) laser diode, which emits light at a single wavelength. Other types of laser diodes, such as distributed feedback (DFB) laser diodes, may also be used. In some embodiments, the light source 202 can be temperature-controlled to ensure stable and accurate performance. Temperature fluctuations can affect the output power and wavelength of the light source 202, which can result in inaccurate measurements. To address this, the light source 202 can be housed in a temperature-controlled oven or thermoelectric cooler to maintain a stable operating temperature.

An optical conduit 204 can be operably coupled to the light source 202 to traverse between the light source 202 and a beginning reference node 206, which in some embodiments can be configured to operably couple to at least one of connectors 110 or connectors 120 of the fiber optic cable 100. A first photodetector 208 and a second photodetector 210 can be positioned along the optical conduit 204, with each of the first photodetector 208 and second photodetector 210 configured to detect an optical signal generated by the light source 202. For example, in one embodiment, at least one of the first photodetector 208 and/or second photodetector 210 can be a reflective linear (RL) sensor, which can optionally be temperature regulated (e.g., contained in a temperature controlled enclosure, etc.). In some embodiments, the second photodetector 210 can be configured to measure the optical power of the light signal that is launched into the fiber in close proximity to the beginning reference node 206 (e.g., sometimes referred to as the launch power measurement).

In some embodiments, a reference loop 212 operably coupled to the optical conduit 204 of a known length can be positioned between the first photodetector 208 and the second photodetector 210. In embodiments, the reference loop 212 can be a loop of optical fiber that is used to set the reference point for the time-of-flight measurements. In particular, a difference in time between detection of the optical signal by the first photodetector 208 and detection of the optical signal by the second photodetector 210 is divided by the known length of the reference loop 212 to determine a velocity of the optical signal.

A third photodetector 214 can be optically coupled to an end reference node 216, which can be configured to couple to an opposite end of the fiber optic cable 100 or components thereof (e.g., fiber extension cable 144). For example, in some embodiments, the end reference node 216 can be configured to receive one of connectors 120, or a bare fiber portion of the fiber extension cable 144. In embodiments, the fiber optic cable 100 is connectable between the beginning reference node 206 and the end reference node 216, such that the third photodetector 214 is configured to detect the optical signal generated by the light source 202 traversing through the fiber optic cable 100, such that a difference in time between detection of the optical signal by the second photodetector 210 and detection of the optical signal by the third photodetector 214 is multiplied by the velocity of the optical signal to determine the total length (A) of the fiber optic cable 100 (or lengths of components or portions thereof).

Having described the preferred aspects and implementations of the present disclosure, modifications and equivalents of the disclosed concepts may readily occur to one skilled in the art. However, it is intended that such modifications and equivalents be included within the scope of the claims which are appended hereto.

What is claimed is:

1. A fiber optic cable having a defined cable length of at least 50 meters, the fiber optic cable comprising:
a fiber extension cable having a first length extending between a first connectorized end and a second end, wherein a length of the fiber extension cable between the first connectorized end and the second end is determined by a time-of-flight process in which an observed travel time for an optical signal traversing from the first connectorized end to the second end is multiplied by a velocity of the optical signal;
a fiber pigtail cable having a second length extending between a third end and a fourth connectorized end,
wherein an initial combined length of the fiber extension cable and the fiber pigtail cable exceeds the defined cable length, wherein at least one of the fiber extension cable in proximity to the second end or the fiber pigtail cable in proximity to the third end is trimmed, and wherein the second end of the fiber extension cable is spliced to the third end of the fiber pigtail cable, and wherein a resulting combined length of the fiber extension cable and the fiber pigtail cable equals the defined cable length within a tolerance of 0.1% of the defined cable length.

2. The fiber optic cable of claim 1, wherein the first connectorized end of the fiber extension cable includes at least one of an MTP/MPO connector, a duplex LC connector, or an LC connector.

3. The fiber optic cable of claim 1, wherein the fourth connectorized end includes at least one of an MTP/MPO connector, a duplex LC connector, or an LC connector.

4. The fiber optic cable of claim 1, wherein the fiber optic cable comprises a trunk portion and one or more breakout sections.

5. The fiber optic cable of claim 4, wherein the trunk portion comprises at least one of 1728, 864, 576, 288, or 96 fibers.

6. The fiber optic cable of claim 1, wherein the fiber optic cable comprises cable in at least one of a ribbon format, stranded format, or loose fiber format.

7. The fiber optic cable of claim 1, wherein at least one of the first connectorized end or fourth connectorized end terminates in a fiber optic panel.

8. The fiber optic cable of claim 7, wherein the fiber optic panel defines a plurality of ports configured to receive a corresponding plurality of adapters.

9. The fiber optic cable of claim 7, wherein the fiber optic panel defines one or more cable management features configured to aid in the storage of excess fiber optic cable.

10. The fiber optic cable of claim 1, wherein the defined cable length measures 100 meters within a tolerance of 0.038% of the defined cable length.

11. The fiber optic cable of claim 1, wherein the defined cable length measures 150 meters within a tolerance of 0.025% of the defined cable length.

12. The fiber optic cable of claim 1, wherein the defined cable length measures 400 meters within a tolerance of 0.01% of the defined cable length.

13. The fiber optic cable of claim 1, wherein the defined cable length measures 500 meters within a tolerance of 0.008% of the defined cable length.

14. The fiber optic cable of claim 1, wherein the defined cable length measures 1000 meters within a tolerance of 0.004% of the defined cable length.

15. The fiber optic cable of claim 1, wherein the defined cable length measures 1500 meters within a tolerance of 0.003% of the defined cable length.

16. The fiber optic cable of claim 1, wherein the defined cable length measures 2000 meters within a tolerance of 0.002% of the defined cable length.

17. The fiber optic cable of claim 1, wherein the defined cable length measures 2500 meters within a tolerance of 0.002% of the defined cable length.

18. The fiber optic cable of claim 1, wherein the defined cable length measures 3000 meters within a tolerance of 0.001% of the defined cable length.

19. The fiber optic cable of claim 1, wherein the defined cable length measures 4000 meters within a tolerance of 0.001% of the defined cable length.

20. A method for producing a fiber optic cable, comprising:
defining a cable length of at least 50 meters;
providing a fiber extension cable having a first length extending between a first connectorized end and a second end;
determining a length of the fiber extension cable between the first connectorized end and the second end, wherein the length of the fiber extension cable is determined by a time-of-flight process in which an observed travel time for an optical signal traversing from the first connectorized end to the second end is multiplied by a velocity of the optical signal;
providing a fiber pigtail cable having a second length extending between a third end and a fourth connectorized end, wherein an initial combined length of the fiber extension cable and the fiber pigtail cable exceeds the defined cable length;
cutting at least one of the fiber extension cable in proximity to the second end or the fiber pigtail cable in proximity to the third end;
splicing the second end of the fiber extension cable to the third end of the fiber pigtail cable, wherein a resulting combined length of the fiber extension cable and the fiber pigtail cable equals the defined cable length within a tolerance of 0.1% of the defined cable length.

21. The method of claim 20, wherein the first connectorized end of the fiber extension cable includes at least one of an MTP/MPO connector, a duplex LC connector, or an LC connector.

22. The method of claim 20, wherein the fourth connectorized end includes at least one of an MTP/MPO connector, a duplex LC connector, or an LC connector.

23. The method of claim 20, wherein the fourth connectorized end includes at least one of an MTP/MPO connector, a duplex LC connector, or an LC connector.

24. The method of claim 23, wherein the fiber extension cable comprises at least one of 1728, 864, 576, 288, or 96 fibers.

25. The method of claim 20, wherein the fiber optic cable comprises cable in at least one of a ribbon format, stranded format, or loose fiber format.

26. The method of claim 20, wherein at least one of the first connectorized end or fourth connectorized end terminates in a fiber optic panel.

27. The method of claim 26, wherein the fiber optic panel defines a plurality of ports configured to receive a corresponding plurality of adapters.

28. The method of claim 26, wherein the fiber optic panel defines a one or more cable management features configured to aid in the storage of excess fiber optic cable.
